(19) United States
(12) Patent Application Publication
(10) Pub. No.: US 2016/0275618 A1
(43) Pub. Date: Sep. 22, 2016

(54) COMPUTER-IMPLEMENTED METHOD, STORAGE MEDIUM AND COMPUTER SYSTEM FOR CREDIT-EQUITY INDEX DATA PROCESSING

(71) Applicant: Deutsche Börse AG, Eschborn (DE)

(72) Inventor: Axel Vischer, Frankfurt am Main (DE)

(21) Appl. No.: 14/968,227

(22) Filed: Dec. 14, 2015

Related U.S. Application Data
(60) Provisional application No. 62/135,418, filed on Mar. 19, 2015.

(51) Int. Cl. G06Q 40/06

(52) U.S. Cl. CPC G06Q 40/06

(57) ABSTRACT

A computer-implemented method is presented to generate an index by determining price information associated with at least one of an equity and an equity-option of a first company, using the price information to estimate a volatility of an equity price of the first company, calculating a default probability based on the estimated volatility and calculating an index level using the calculated default probability.

This application claims the benefit of U.S. Provisional Application No. 62/135,418, filed Mar. 19, 2015, the disclosure of which is hereby incorporated by reference in its entirety.

### BACKGROUND OF THE INVENTION

1. Field of the Invention

The invention relates to data processing apparatus and methods and, more particularly, to processing data relating to equity markets and fixed income markets.

2. Description of the Related Art

Indices which are built from a number of constituents are well known in the art. Generally, in economics and finance, an index (for example a price index or stock market index) is a benchmark of activity, performance or any evolution in general. Well known indices are, for instance, the American Dow Jones Industrial Average and S&P 500 Index, the British FTSE 100, the Japanese Nikkei 225 and the German DAX.

Taking the Dow Jones Industrial Index as an example, in order to calculate the benchmark, the sum of the prices of the 30 stocks used to determine the benchmark is divided by a divisor. The divisor is adjusted in case of splits, spin-offs or similar structural changes, to ensure that such events do not in themselves alter the numerical value of the benchmark. Since the price of each component stock of the Dow Jones Industrial Average is the only consideration when determining the value of the index, the price movement of even a single security will heavily influence the value of the index even though the dollar shift is less significant in a relatively highly valued issue.

In contrast to such a price-weighted index, market value or capitalization weighted indices, such as the German DAX, factor in the size of a company. Therefore, a relatively small shift in the price of a large company will heavily influence the value of the index.

Derivates such as futures or options have become increasingly important in the world of finance. Futures and options are now traded actively on many exchanges throughout the world. A derivative is a financial instrument whose value depends on or derives from the values of other, more basic underlying variables. Very often, the variables underlying derivatives are the prices of traded assets. A stock option, for example, is a derivative whose value is dependent on the price of a stock.

A derivative exchange is a market where individuals trade standardized derivatives contracts that have been defined by the exchange. Traditionally, derivatives traders have met on the floor of an exchange and used shouting and a complicated set of hand signals to indicate the trades they would like to carry out. This is known as the open outcry system. In recent years, exchanges have increasingly moved from the open outcry system to electronic trading.

Equity derivatives are derivative instruments where the underlying asset is an equity security. The major type of equity asset is individual stocks/shares and equity indexes, wherein the term “share” and “stock” may be used interchangeably. Equity indexes are a weighted basket of individual stocks.

Equity derivative products are functionally identical with derivatives on other asset classes. Equity derivatives can be segmented into instruments such as forwards, options or structured notes, and/or markets, such as exchange-traded or over the counter markets.

Credit derivatives products are traditional derivatives re-engineered to a credit orientation. The underlying asset in credit derivatives is credit risk on an underlying bond, loan or other financial instrument. Credit derivatives are defined as a class of financial instrument, the value of which is derived from an underlying market value driven by the credit risk of private or government entities other than the counterparties to the credit derivative transaction itself.

More details on financial indices, derivatives in general and equity derivatives and credit derivatives in particular may be found in “Swaps/Financial Derivatives, Products, Pricing, Applications and Risk Management”, 3rd edition, Satyajit Das, John Wley & Sons (Asia) Pte Ltd, ISBN 0-470-82109-4.

Equity valuations and credit risk are fundamental properties of the financial condition of a company. Therefore, the information content of equity derivatives and credit derivatives should be directly linked and comparable. As an index is a benchmark of any evolution, it would be desirable to have an index representing a gauge for both tail risk in the equity market as well as default risk in credit markets over a given time horizon.

### SUMMARY OF THE INVENTION

To arrive at the above formulated needs and to overcome disadvantages of prior art techniques, the present invention provides new data comprising index data through a new data manipulation process of a plurality of data sets in a computational efficient manner. According to embodiments of the invention, it is provided a computer-implemented method executed by one or more computing devices and a tangible, non-transitory, computer-readable storage medium that stores a set of executable instructions that, when executed, cause a computer to perform operations for manipulating a plurality of data sets to generate a final data set, wherein the final data set comprises data representing an index and the plurality of data sets comprises a first data set, a second data set and third data set. First, the first data set is determined, wherein the first data set comprises price information associated with at least one of an equity and an equity-option of a first company. Next, the first data set is used to generate the second data set, wherein generating the second data set comprises reading the price information from the first data set, estimating a volatility of an equity price of the first company based on the read price information, and writing the estimated volatility to the second data set. Thereafter, the second data set is used to generate the third data set, wherein generating the third data set comprises reading the estimated volatility from the second data set, calculating a default probability based on the estimated volatility, and writing the default probability to the third data set. The default probability is a probability that the equity becomes worthless over a defined time horizon. Finally, the third data set is used to generate the final data set, wherein generating the final data set comprises reading the default probability from the third data set, calculating an index level using the calculated default probability and storing the calculated index level to the data representing the index. The final index construction can represent a default likelihood, a credit spread, or some other mathematical measures related to the equity and credit markets.

### BRIEF DESCRIPTION OF THE DRAWINGS

The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following and more particular description of the invention, as illustrated in the accompanying drawings, wherein:

FIG. 1 illustrates a process for generating index data; and

FIG. 2 illustrates a computer architecture for carrying out the invention.

### DETAILED DESCRIPTION OF THE INVENTION

The illustrative embodiments of the present invention will be described with reference to the figure drawings, wherein like elements and structures are indicated by like reference numbers.

The present invention may be operational with numerous general purpose or special purpose computing systems environments or configurations. Examples of well-known computing systems, environments and/or configurations that may be suitable for use with the invention may include, but are not limited to: personal computers, server computers, handheld or laptop devices, multi-processor systems, micro-processor based systems, network PCs, mini computers, tablet computers, smart phones, mainframe computers, distributed computing environments that include any of the above systems or devices, and the like.

The invention may be described in the general context of computer executable instructions, such as program modules, being executed by a computer.

The invention provides an index reflective of the relationship between credit and equity markets. This is an important trading signal which is difficult to capture. The index represents a gauge for both tail risk in the equity market as well as default risk in credit markets over a given time horizon.

The index can be used as a relative value signal to trade equity derivatives referencing the basket of underlying index constituents against CDS (credit default swap) on liabilities referencing the entities of the same basket. The invention also allows for the calculation of sensitivities (known as and also referred to as Greeks) related to the index basket, which is an indispensable tool in trade construction. Currently there is no credit index or credit index derivative which allows for the same in depth analysis of equity equivalent sensitivities (Greeks).

Typically the index will be made up of a basket of constituents similar to the baskets used in OTC credit indices or some of the major blue-chip equity indices. But, the basket can also be reduced to one underlying only. The invention then allows for the calculation of a single name credit index, which can be used to settle a single name credit derivative. In this way the invention allows for a systematic deployment of a listed market for single name credit derivatives.

Equity valuations and credit risk are fundamental properties of the financial condition of a company. As such the information content of equity derivatives and credit derivatives should be directly linked and comparable. The index generated by the present invention aims at extracting information on credit risk, like the default term structure and credit spreads of index basket constituents out of equity and equity-option prices.

Specifically, an equity-option comprises detailed information about the well-being of the underlying company. Such information includes the company's likelihood of default (default probability) in the near future. For example, one might buy a low strike put to protect against a catastrophic price decline.

The invention extracts the likelihood of default for all constituents of a basket of equities such as stocks over a pre-defined time horizon. As detailed below, prices of equity-options on basket constituents may be extracted and the constituents' default risks may be aggregated into an index value representing the probability that any of the index constituents defaults.

In a first step a model containing explicitly the information about the default of a company is applied to extract fundamental parameters of the credit market, like default probabilities and credit spreads. Typical models considered in embodiments of the present invention are the Constant Elasticity of Variance (CEV) model, the Jump to default Constant Elasticity of Variance (JCEV) model and also more complex Stochastic Volatility Models.

The Constant Elasticity of Variance (CEV) model describes the evolution of an equity price S as:

dS=μSdt+σS^{α}dZ (1)

where μ is the drift of the equity price, a is the volatility (standard deviation) parameter of the equity price and a is an elasticity parameter, which is a measure for the skew and dZ is a Wiener process. As noted in the background, the equity may be a share of a company. Accordingly, the term “equity price” may be used synonymously with the term “share price”.

The Jump to default CEV model (JCEV) extends this evolution with a time and state dependent default intensity A as:

dS=μSdt+σSadZ+λSdt. (2)

The default intensity λ is dependent on the equity price and can be modeled as a Poison process.

Finally, by allowing the volatility a to be dependent on the equity price too, the model can be extended to be of a Stochastic Volatility Model type.

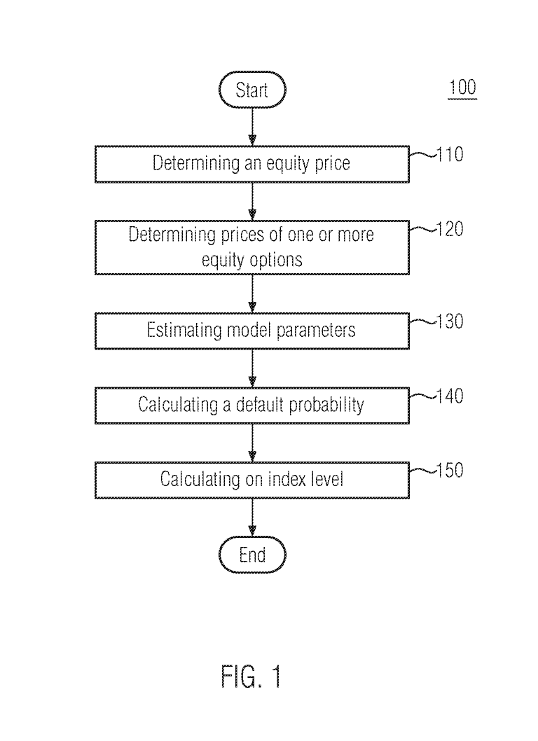

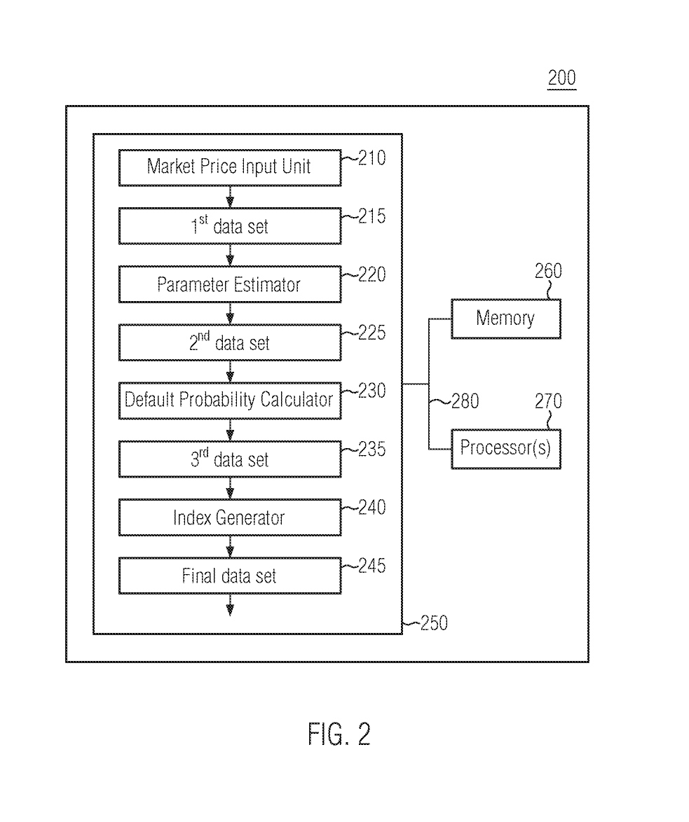

All these models can be used and solved in embodiments of the present invention. While any of these models may be used in embodiments of the present invention, FIG. 1 and FIG. 2 will now be described using the CEV model and a standard Black-Scholes (B-S) model.

In particular, the CEV model aims to calculate a cumulative default probability of a company over a given time period, also referred to as time horizon, (e.g. 5 years) as implied by the equity market. Once an implied default probability is known, standard CDS pricing models can be used to calculate the spread on a par CDS given this default probability and an assumption about recovery rates.

Turning now to FIG. 1, FIG. 1 generally illustrates a method 100 for generating a final data set comprising index data through the manipulation of a plurality of data sets. Steps 110 and 120 generate a first data set which is used as input data set for step 130. Step 130 generates a second data set which is used as input data set for step 140. Moreover, step 140 generates a third data set which is then used as input data set for step 150. Finally, step 150 generates the final data set which comprises data representing the inventive index.

In particular, at steps 110 and 120, the first data set is determined, wherein the first data set comprises price information associated with at least one of an equity and an equity-option of a first company.

In the CEV model (equation (1)), both a and a need to be estimated in order to derive the equity price evolution. In the standard Black-Scholes (B-S) model, only an estimate for a, the volatility, is needed, since the B-S model is defined by equation (1), where a is equal to 1.

The CEV model provides a diffusion process effective at mapping equity volatility to credit quality, and is used to derive default likelihoods from equity and equity-options prices. The CEV model can describe local volatility increases as the underlying equity price decreases, and unlike Black-Scholes, allows for equity prices to go to zero, analogous to a firm default.

The CEV model is a reduced-form model, based on simple, observable market inputs. In contrast to many credit models, which require detailed knowledge of a company's capital structure, the CEV model infers a company's probability of default solely from traded equity and equity-option market prices. As a result, the CEV model provides a real-time, forward-looking measure of a company's credit risk.

The CEV model represents “bankruptcy” by proxy through information obtained in the equity market. The CEV model defines default as the point when equity is worthless (e.g. share price equals zero) and describes a suitable stochastic process for the equity price that allows for the share price to hit zero. In embodiments, “bankruptcy” may be defined as a share price falling below a certain threshold, e.g. USD 0.50.

According to embodiments of the present invention, these parameters a and a are taken from historical observations.

In alternate embodiments, the parameters a and a are implied from the traded market prices of options (in the equity markets as standard we refer to this implied a parameter as implied volatility). In those embodiments, for instance, at step 110 an equity price (such as a share price) of a company may be determined and at step 120 prices of one or more equity-options may be determined. Further, a dividend yield and an interest rate for the equity may be determined. The determined equity price, equity-option prices, dividend yield and interest rate may be stored in the first data set as the price information.

Accordingly, for the CEV model, the values of a and a are implied from the market. Specifically, equity price and options prices, dividend yields and interest rates are used to do this. As there are two parameters (a and a) for the CEV model, more than one option price is needed in order to solve for these two parameters. In embodiments, the inputs used to do this are the options prices in the market. For instance, the 70% to 110% strikes are used for both 6 months and 1 year maturity options. Other strike and maturity combinations are possible, for example one could use the 80% and 100% strike only.

For the B-S model, prices from only one option are needed in order to solve equation (1). For instance, the 70% to 110% strikes are used for the 6 month or the 1 year maturity options.

At step 130, when using the B-S model, the second data set is generated by reading the price information from the first data set, estimating a volatility of the equity price of the company based on the read price information, and writing the estimated volatility to the second data set. At step 130, when using the CEV model, the second data set is generated by reading the price information from the first data set, estimating a volatility and an elasticity parameter of the equity price of the company based on the read price information, and writing the estimated volatility and the estimated elasticity parameter to the second data set. The volatility may be determined based on the determined equity price and the determined prices of the equity-option(s) (for the B-S model, the prices of one equity-option are sufficient as explained above; the CEV model needs at least the prices of two equity-options)

Specifically, in order to calculate the values of a and a implied by prices of equity-options, the price of a call (or the price of a put) given by the CEV model is used.

The price of a European call c and put p under the CEV model where α<1 is given as:

c=S₀e^{-qT}[1−χ²(a,b+2,c)]−Ke^{-rT}χ²(c,b,a) (3a)

p=Ke^{-rT}[1−χ²(c,b,a)]−S₀e^{-qT}χ²(a,b+2,c) (3b)

where,

$$a = \frac{{[ K {e}^{- ( r - q ) T} ]}^{2 ( 1 - α )}}{{( 1 - α )}^{2} v} , b = \frac{1}{1 - α} , c = \frac{{S}^{2 ( 1 - α )}}{{( 1 - α )}^{2} v}$$

$$with v = \frac{{σ}^{2}}{2 ( r - q ) ( α - 1 )} [ {e}^{2 ( r - q ) ( α - 1 ) T} - 1 ]$$

Where S0 is the current equity price, q is the dividend yield, T is the time to maturity, r is the risk-free rate (interest rate), K is the option strike and χ2(z,k,v) is the cumulative probability that a variable with a non-central χ2 distribution with non-centrality parameter v and k degrees of freedom is less than z.

As outlined above, for a standard Black-Scholes model, only a value of a (the volatility) is implied so only prices of one equity-option are needed to do this. For the CEV model prices of at least two equity-options are needed as the equations (3a) and (3b) need to be solved for both a value of a and for a. The fitting algorithm for the CEV model may be as follows:
a) Take 6-month and 1-year expiry calls and puts struck between 70% and 110% of the equity price at intervals of 10%.
b) Fit the CEV model option prices to the observed option prices in a non-linear least-squares sense. Additional input parameters may be the dividend yield of the company and the current market interest rates. For example, if the underlying equity price is 100, the 6-month and 1-year options may be used taking strikes of 70, 80, 90, 100 (put options) and 110 (call option). This gives 10 observed options prices. Use an initial estimate for the starting values of a and a and price each of the options under the CEV model. Compute the sum of the squared differences between the CEV prices and the observed market prices. Then iterate selecting new values of a and a to reduce this sum of squares until a minimum is found.

The results of this process are values of a and a that best fit the current market option prices. This describes the process of the underlying equity price and hence the probability distribution for the equity price for different points in time.

At step 140, when using the B-S model, the second data set is used to generate the third data set by reading the estimated volatility from the second data set, calculating a default probability based on the estimated volatility, and writing the default probability to the third data set. The default probability is a probability that the equity price hits zero over a defined time horizon. At step 140, when using the CEV model, the elasticity parameter is additionally read from the second data set and the default probability is calculated based on the estimated volatility and the estimated elasticity parameter. In some embodiments, a recovery rate is additionally determined at step 140 and written to the third data set.

In particular, as outlined above, the values of a and a may be fit from the options prices observed in the market. This allows to fit a probability distribution (a non-central chi-squared distribution) of the equity price of the company.

Under the CEV model, default is defined as the point when equity becomes worthless. Therefore, the cumulative probability of default to time T is simply the probability that the company's equity price hits zero by time T. Fortuitously, closed-form solutions exist for computing this probability, making the CEV model highly tractable.

Thus, the probability of default may be the probability that the equity becomes worthless (e.g. the equity price hits zero) over a time horizon T that is considered (i.e. 1 year for a 1 year credit default swap).

Recalling the option pricing formulae in (3a) and (3b), the probability of default over time horizon T is given by:

[Prob of Default Prior to T]=Pr(ST=0)=[1−χ2(c,b,a)] (4)

using the distribution with the inferred σ and α.

This allows to calculate a cumulative probability of default and survival probability (1−Cum Prob of Default) for any time horizon T.

If TCDS represents the maturity of the CDS wished to be valued, a probability of default for each CDS cash flow i is calculated, for i=1 to TCDS×Δ, where Δ is the year fraction of the cash flows of the CDS (e.g. 0.25 for a standard CDS that pays cash flows every quarter). The CDS curve is then bootstrapped in that the conditional default probability (hazard rate) implied by the CEV model is used for each period when calculating the spread to a given maturity.

Now the calculation of the CDS spread will be described. With the above, it is possible to calculate a default and survival probability for each CDS cash flow. This is not quite enough to price CDS. Equation (5) shows the pricing formula for a par credit default swap in discrete time. The missing variable is R, the recovery rate. This recovery rate may be pre-defined or pre-determined. In order to help price under standard market assumptions (to best approximate a market CDS) a recovery rate of 40% may be used. The CDS pricing equation (5) may be then solved to find ST, which is the CDS spread for a par CDS with maturity T.

$$\underbrace{Sn {\sum }_{i = 1}^{n} Δ i , Psi , DFi + Accrual on Default}_{PV ( Fee Leg )} = \underbrace{( 1 - R ) \cdot {\sum }_{i = 1}^{n} ( Ps ( i - 1 ) - Psi ) DFi}_{PV ( Contingent Leg )} \qquad ( 5 )$$

where Sn is the spread for protection to period n, Δi is the length of time period i in years, Psi is the probability of survival to time i, DFi is the risk-free discount factor to time i, R is the recovery rate on default and

$$Accrual on Default = Sn {\sum }_{i = 1}^{n} \frac{Δ i}{2} ( Ps ( i - 1 ) - Psi ) DFi$$

Using the CEV model in conjunction with the standard CDS pricing formula (5), the sensitivities, (Greeks) of CDS spreads may be derived to equity (such as share) price and volatility. These Greeks have their familiar counterparts in the option markets, and are useful for risk management, hedging and trade construction.

Specifically, the following Greeks may be defined:

Spread Delta as the change in CDS spread for a 1% change in the equity (e.g. share) price:

$$\frac{\partial CDS}{\% \partial S} ( S ; α , σ , T , R ) \approx \frac{CDS ( S \times 1.01 ) - CDS ( S \times 0.99 )}{2}$$

Spread Gamma as the change in Spread Delta for a 1% change in the equity (e.g. share) price:

$$\frac{{\partial }^{2} CDS}{\% \partial {S}^{2}} ( S ; α , σ , T , R ) \approx \frac{CDS ( S \times 1.01 ) - 2 \times CDS ( S ) + CDS ( S \times 0.99 )}{4}$$

Spread Vega as the change in CDS spread for a percentage point increase in Black-Scholes-equivalent at-the-money (ATM) implied volatility:

$$\frac{\partial CDS}{\% \partial {σ}_{BS}} ( S ; α , σ , T , R ) \approx CDS ( S ; α , σ + 0.01 \times {S}^{1 - α} , T , R ) - CDS ( S ; α , σ , T , R )$$

Here R is the recovery rate pre-set or implied.

The delta, gamma, and vega sensitivities give the appropriate number of shares of stock, options contracts or notional amount of variance swaps to use when constructing trades or hedges.

Thus, the CEV model provides a framework for directly comparing equity and credit, with direct applications to hedging, trading, sales and research. Below some general themes are outlined that demonstrate how the CEV model can be used in practice.

a) Hedging
The Greeks can be used to construct hedge ratios between the equity and credit markets. For example, a trader who is short protection can use the CDS spread DVOI and the CEV Spread Delta to calculate the number of shares of the company that must be sold as a hedge.

b) Relative Value Trading
By analyzing the historical relationship between a company's CDS spread and the CEV-model spreads, a trader can gauge whether a company's equity and credit markets are misaligned.

### Trade Example #1

CDS spreads appear “too low” relative to CEV-model spreads. A trader could buy protection in the CDS market, buy shares of the stock, and sell equity volatility.

### Trade Example #2

CDS spreads appear “too high” relative to the CEV-model spreads, possibly because low-strike out-of-the-money equity puts are too cheap.
A trader could buy these puts outright as a proxy for credit protection, or sell protection and buy the puts as a hedge.

### Trade Example #3

CDS spreads appear “too low” relative to the CEV-model spreads, possibly implying that equity volatility is too high, or the volatility skew is too steep. A trader could sell straddles, or buy a put-spread on the company.

c) Momentum Trading
The CEV model can be used to signal shifts in either the CDS or the equity option market for a company. A trader could compare the CEV-model spread with the observed market CDS spread and interpret any significant deviation from the mean as a trading opportunity.

d) Implied Recovery Rate
The CEV model can be used to infer a recovery rate for CDS contracts. Using the standard CDS pricing formula, the observed CDS spread and the CEV-model default probabilities, the model can be solved for the implied recovery rate, R.

While the above description demonstrates the application to the CEV model, similar processes are used for any of the other models applicable and usable, in particular JCEV, Sabre and other Stochastic Volatility models.

At step 150 the third data set is used to generate the final data set by reading the default probability from the third data set, calculating an index level using the calculated default probability and storing the calculated index level to the data representing the index. In embodiments where the third data set comprises additionally a recovery rate, this recovery rate is also read from the third data set and the index level is calculated based on the default probability and the recovery rate.

Steps 110 to 150 have been described for equity prices and equity-option(s) prices of a single company. Thus, the basket of constituents underlying the index consists of only one constituent. Accordingly, a single name credit index is actually calculated. Such an index can be used to settle on-exchange listed single name credit derivatives. A market consisting of several single name credit derivatives could be linked to a market credit index derivative. If the market credit index—referencing a basket of several constituents—is evaluated through a simple average of the constituent single name values, then the index derivative is also linked to the underlying single name derivatives through single averaging.

According to other embodiments, steps 110 to 150 may be performed for a plurality of companies. In those embodiments, the basket of constituents underlying the index consists of the plurality of companies as the constituents.

The index may be constructed using various construction approaches such as a simple averaging strategy whereby the level of the index is set to an equally weighted average of the constituent CEV spreads using equation (5) and a pre-set or implied recovery rate. Such an index is able to produce an index that tracks the Markit CDX and iTraxx indices and various other credit indices to a high degree of accuracy, tracking all of the major troughs, peaks and trends. Accordingly, the CDX index and the iTraxx can be synthetically replicated using the embodiments of the invention

Thus, according to embodiments of the invention, the index is an equally weighted average over the credit spreads implied out of equity option prices over all index constituents. An overall adjustment factor may be applied, such that the credit spread levels extracted from the equity market are in line with the credit levels form the credit market. This adjustment factor is historically constant and set at inception of the index based on a historical comparison of the two time series

Accordingly, the CEV model may be applied to generate an index that represents the average default risk of a basket of companies. For instance, US based indices may be considered or non-US based indices provided that there is a sufficiently developed equity-option market.

As seen above, information required to generate the default probability for a given company is the company's traded equity and equity-option market prices. According to embodiments, the dividend yield and interest rate may be required, too

According to other embodiments, the index may include different constituent selection schemes such as. selecting the top 100 stocks with the largest market capitalisation, selecting the same stocks as in some of the broad market indices, selecting the top 100 names with the largest credit spreads or default probabilities, selecting a set of the largest and most liquid names in such a way that the resulting index is a close proxy to existing credit indices etc. In addition, different weighting schemes may be used such as weighting with the market capitalisation of a stock, weighting with the default probability of the stock over a certain time horizon, etc. Moreover, credit events may be treated differently, such as using the definition of the credit event from OTC Credit markets. Further, different observables or index levels may be used. For instance, next to credit spreads, one might use default likelihoods, expected loss, Value at Risk or similar mathematical quantities over a certain time horizon. In addition, different calibration schemes to adjust overall index levels to market observables may be used such as calibrate a scaling factor to adjust the model credit spreads to market credit spreads (it should be noted here that this scaling factor is not needed if non-credit spread related index observables are used, e.g. the default likelihood over a certain time horizon).

Indices can be developed for all major geographic areas, in particular the US and Europe.

Accordingly, at step 150, outputs of the calculation, i.e. the third data set, may be used as input for an index level calculation. Outputs of the calculation may be the default probability (also referred to as default likelihood) over a given time horizon per company, credit spread over a given time horizon per company, expected loss or value at risk or other risk measures over a given time horizon per company. Those outputs of the calculation may be weighted using different weighting schemes such as simple averaging, market capitalisation weighted averaging and other averaging mechanisms. For instance, Credit spreads may be combined with simple averaging and expected loss may be combined with market capitalisation weighting.

Typically a credit event for such an index generated in line with the present invention will only be triggered if and when the respective equity options on one of the index constituents are not trading anymore—i.e. they are put on hold by their respective listing venues. In this case the respective constituent will be taken out of the continuous dissemination procedure and instead reflect only a fixed value. For an equal weighted index this fixed value might be 1/number of constituents multiplied by a recovery rate. This recovery rate can be a pre-defined value or a market standard, e.g. 40%, or it is implied out of the underlying equity options using a pre-determined time period and other predetermined input data.

Accordingly, the index may be used to link both credit and equity markets. Further, the index may be constructed to represent tail risk or the index may be constructed to represent a credit and default risk. Further, the index may be used to establish a listed single name credit derivatives market and to settle the single name credit derivatives against the index. In addition, the index may be used to establish a listed multiple names credit derivatives market and to settle the multiple names credit derivatives against the index.

FIG. 2 illustrates a computer architecture 200 for carrying out the method 100 disclosed with respect to FIG. 1. The computer architecture may include one or more computing devices having one or more processors 270. Instructions are recorded on tangible media and are executed by the one or more processors 270 to carry out the disclosed functions. The architecture includes a unit 250 and a memory 260. The unit 250 may include a market price input unit 210, a parameter estimator 220, a default probability calculator 230 and an index generator 240. All elements 210, 220, 230, 240 and 250 communicate with memory 260 and the one or more processors 270 via bus 280. Steps 110 and 120 of FIG. 1 are performed by market price input unit 210 to generate the first data set 215. Step 130 of FIG. 1 may be performed by parameter estimator 220 to generate the second data set 225. Step 140 may be performed by default probability calculator 230 to generate the third data set 235. Finally, step 150 of FIG. 1 may be performed by the index generator 240 to generate the final data set 245 which may be output or stored.

While the invention has been described with respect to the physical embodiments constructed in accordance herewith, it will be apparent to those skilled in the art that various modifications, variations and improvements of the present invention may be made in the light of the above teachings and within the purview of the appended claims without departing from the spirit and intended scope of the invention. Accordingly, it is to be understood that the invention is not limited by the specific illustrative embodiments, but only by the scope of the appended claims.

1. A computer-implemented method executed by one or more computing devices for manipulating a plurality of data sets to generate a final data set, the final data set comprising data representing an index and the plurality of data sets comprising a first data set, a second data set and third data set, the method comprising:
determining the first data set, the first data set comprising price information associated with at least one of an equity and an equity-option of a first company;
using the first data set to generate the second data set, wherein generating the second data set comprises reading the price information from the first data set, estimating a volatility of an equity price of the first company based on the read price information, and writing the estimated volatility to the second data set;
using the second data set to generate the third data set, wherein generating the third data set comprises reading the estimated volatility from the second data set, calculating a default probability based on the estimated volatility, the default probability being a probability that the equity becomes worthless over a defined time horizon, and writing the default probability to the third data set; and
using the third data set to generate the final data set, wherein generating the final data set comprises reading the default probability from the third data set, calculating an index level using the calculated default probability and storing the calculated index level to the data representing the index.

2. The computer-implemented method of claim 1, wherein:
determining the first data set comprises determining the equity price of the first company, determining prices of a first equity-option of the first company, determining a dividend yield of the first company, determining a current market interest rate and storing the determined equity price, the determined prices of the first equity-option, the determined dividend yield and the determined current market interest rate as the price information; and
estimating the volatility of the equity price of the first company comprises estimating the volatility based on the determined equity price and the determined prices of the first equity-option.

3. The computer-implemented method of claim 2, wherein:
determining the first data set further comprises determining prices of a second equity-option of the first company and storing the determined prices of the second equity-option in the price information; and
estimating the volatility comprises estimating the volatility based on the determined equity price, the determined prices of the first equity-option and the determined prices of the second equity-option;

4. The computer-implemented method of claim 3, wherein:
generating the second data set further comprises estimating an elasticity parameter based on the determined equity price, the determined prices of the first equity-option and the determined prices of the second equity-option, and writing the elasticity parameter to the second data set; and
generating the third data set further comprises reading the elasticity parameter from the second data set and calculating the default probability based on the estimated volatility and the estimated elasticity parameter.

5. The computer-implemented method of claim 4, wherein estimating the volatility and estimating the elasticity parameter comprises:
estimating an initial volatility of the equity price;
estimating an initial elasticity parameter;
calculating a price of the first equity-option using the estimated initial volatility and the estimated initial elasticity;
calculating a price of the second equity-option using the estimated initial volatility and the estimated initial elasticity;
computing a sum of squared differences between the calculated prices and the determined prices of the equity-options; and
iteratively selecting new values for the volatility and the elasticity parameter to reduce the sum of differences until a minimum sum is found.

6. The computer-implemented method of claim 1, wherein:
generating the third data set further comprises determining a recovery rate and writing the recovery rate to the third data set; and
generating the final data set comprises reading the recovery rate from the third data set and calculating the index level using the calculated default probability and the determined recovery rate.

7. The computer-implemented method of claim 1, wherein:
the price information is associated with equities and equity-options of a plurality of companies, the plurality of companies comprising the first company,
generating the second data set further comprises estimating a volatility of a equity price for each company of the plurality of companies, and writing the estimated volatilities to the second data set,
generating the third data set comprises reading the volatilities from the second data set, calculating default probabilities based on the estimated volatilities and writing the default probabilities to the third data set, and
generating the final data set comprises reading the default probabilities from the third data set, calculating an index level using the calculated default probabilities and storing the index level to the final data set.

8. The computer-implemented method of claim 7, wherein generating the third data set comprises calculating one of a credit spread over a given time horizon per company, expected loss over a given time horizon per company and a value at risk over a given time horizon per company and wherein calculating the index level comprises weighting one of the default probability, the credit spread, the expected loss and the value at risk using a weighting scheme, the weighting scheme being one of simple averaging, weighting with a market capitalization of the equities and weighting with the default probabilities of the equities over a given time horizon.

9. The computer-implemented method of claim 1, wherein the index is used to link both credit and equity markets.

10. The computer-implemented method of claim 1, wherein the index is constructed to represent a gauge for a tail risk.

11. The computer-implemented method of claim 1, wherein the index is constructed to represent a gauge for a credit and default risk.

12. The computer-implemented method of claim 1, further comprising:
establishing a listed single name credit derivatives market; and
settling the single name credit derivatives against the index.

13. The computer-implemented method of claim 7, further comprising:
establishing a listed multiple names credit derivatives market; and
settling the multiple names credit derivatives against the index

14. A tangible, non-transitory, computer-readable storage medium that stores a set of executable instructions for manipulating a plurality of data sets to generate a final data set, the final data set comprising data representing an index and the plurality of data sets comprising a first data set, a second data set and third data set, the instructions when executed causing a computer to perform operations comprising:
determining the first data set, the first data set comprising price information associated with at least one of an equity and an equity-option of a first company;
using the first data set to generate the second data set, wherein generating the second data set comprises reading the price information from the first data set, estimating a volatility of an equity price of the first company based on the read price information, and writing the estimated volatility to the second data set;
using the second data set to generate the third data set, wherein generating the third data set comprises reading the estimated volatility from the second data set, calculating a default probability based on the estimated volatility, the default probability being a probability that the equity becomes worthless over a defined time horizon, and writing the default probability to the third data set; and
using the third data set to generate the final data set, wherein generating the final data set comprises reading the default probability from the third data set, calculating an index level using the calculated default probability and storing the calculated index level to the data representing the index.

15. A computer system comprising a memory and one or more processors, the computer system being configured to manipulate a plurality of data sets to generate a final data set, the final data set comprising data representing an index and the plurality of data sets comprising a first data set, a second data set and third data set, the computer system comprising:
a market price input unit configured to determine the first data set, the first data set comprising price information associated with at least one of an equity and an equity-option of a first company;
a parameter estimator configured to use the first data set to generate the second data set, wherein generating the second data set comprises reading the price information from the first data set, estimating a volatility of an equity price of the first company based on the read price information, and writing the estimated volatility to the second data set;
a default probability calculator configured to use the second data set to generate the third data set, wherein generating the third data set comprises reading the estimated volatility from the second data set, calculating a default probability based on the estimated volatility, the default probability being a probability that the equity becomes worthless over a defined time horizon, and writing the default probability to the third data set; and
an index generator configured to use the third data set to generate the final data set, wherein generating the final data set comprises reading the default probability from the third data set, calculating an index level using the calculated default probability and storing the calculated index level to the data representing the index.
